(19) United States
(12) Patent Application Publication
(10) Pub. No.: US 2023/0008227 A1
(43) Pub. Date: Jan. 12, 2023

(54) ANALYSIS APPARATUS, DATA GENERATION METHOD, AND NON-TRANSITORY COMPUTER READABLE MEDIUM

(71) Applicant: NEC Corporation, Tokyo (JP)

(72) Inventor: Masaya FUJIWAKA, Tokyo (JP)

(73) Assignee: NEC Corporation, Tokyo (JP)

(21) Appl. No.: 17/851,139

(22) Filed: Jun. 28, 2022

(30) Foreign Application Priority Data
Jul. 8, 2021 (JP) 2021-113647

(51) Int. Cl. G06T 7/62; G06T 19/00; G06V 10/25

(52) U.S. Cl. CPC G06T 7/62; G06T 19/006; G06V 10/25; G06V 2201/07

(57) ABSTRACT

An analysis apparatus includes: a communication unit configured to receive first three-dimensional sensing data from a first sensor and receive second three-dimensional sensing data from a second sensor provided in a position different from a position where the first sensor is provided; a calculation unit configured to calculate a transformation parameter used to transform a reference model indicating the three-dimensional shape of the target object into a three-dimensional shape of the target object indicated by the first and second three-dimensional sensing data; a correction unit configured to correct a transformation parameter in such a way that the reference model is transformed into a three-dimensional shape of the target object at the first timing based on a difference between the first timing and the second timing; and a generation unit configured to generate three-dimensional data obtained by transforming the reference model using the transformation parameter after the correction.

### INCORPORATION BY REFERENCE

This application is based upon and claims the benefit of priority from Japanese patent application No. 2021-113647, filed on Jul. 8, 2021, the disclosure of which is incorporated herein in its entirety by reference.

### TECHNICAL FIELD

The present disclosure relates to an analysis apparatus, a data generation method, and a program.

### BACKGROUND ART

In recent years, xR communication has been widely used as highly realistic communication in which a real space and a virtual space are merged. The xR communication includes Virtual Reality (VR) communication, Augmented Reality (AR) communication, and Mixed Reality (MR) communication. In the xR communication, three-dimensional data in one space A is forwarded to another space B, where the situation in the space A is reproduced in a simulated manner. For example, three-dimensional data acquired by a three-dimensional (3D) camera in the space A is forwarded to the space B, where a stereoscopic image which is based on the forwarded three-dimensional data is displayed using an AR device.

Published Japanese Translation of PCT International Publication for Patent Application, No. 2017-539169 discloses a configuration of an AR system that uses image frames output from a color camera and a depth camera. In Published Japanese Translation of PCT International Publication for Patent Application, No. 2017-539169, the color camera and the depth camera are unsynchronized with each other, and a timing when the image frame output from the color camera is captured differs from a timing when the image frame output from the depth camera is captured. In Published Japanese Translation of PCT International Publication for Patent Application, No. 2017-539169, image frames output from the respective cameras are synchronized with each other by comparing features of the image frame output from the color camera with features of the image frame output from the depth camera.

### SUMMARY

However, there is a problem in the AR system disclosed in Published Japanese Translation of PCT International Publication for Patent Application, No. 2017-539169 that image frames output from the respective cameras cannot be synchronized with each other if a target object has moved significantly between timings when the respective cameras capture the images. Or even when image frames output from the respective cameras could be synchronized with each other in a case in which the target object has moved significantly between the timings when the respective cameras capture the images, image frames having features different from each other end up being synchronized with each other. A case in which the target object has moved significantly may be, for example, one in which the amount by which the target object has moved has exceeded a predetermined value. This causes a problem that the quality of the virtual object provided by the AR system is reduced.

One of the objects of the present disclosure is to provide an analysis apparatus, a data generation method, and a program capable of generating high-quality three-dimensional data using data output from a plurality of sensors even when the plurality of sensors are unsynchronized with each other.

An analysis apparatus according to a first aspect of the present disclosure includes: a communication unit configured to receive first three-dimensional sensing data indicating a result of sensing a target object from a first sensor at a first timing and second three-dimensional sensing data indicating a result of sensing the target object from a second sensor provided in a position different from a position where the first sensor is provided at a second timing; a calculation unit configured to calculate a transformation parameter of a representative point of a reference model used to transform a reference model indicating a three-dimensional shape of the target object into a three-dimensional shape of the target object indicated by the first three-dimensional sensing data and the second three-dimensional sensing data; a correction unit configured to correct the transformation parameter in such a way that the reference model is transformed into a three-dimensional shape of the target object at the first timing based on a difference between the first timing and the second timing; and a generation unit configured to generate three-dimensional data obtained by transforming the reference model using the transformation parameter after the correction.

A data generation method according to a second aspect of the present disclosure includes: receiving first three-dimensional sensing data indicating a result of sensing a target object from a first sensor at a first timing and receiving second three-dimensional sensing data indicating a result of sensing the target object from a second sensor provided in a position different from a position where the first sensor is provided at a second timing; calculating a transformation parameter of a representative point of a reference model used to transform a reference model indicating a three-dimensional shape of the target object into a three-dimensional shape of the target object indicated by the first three-dimensional sensing data and the second three-dimensional sensing data; correcting the transformation parameter in such a way that the reference model is transformed into a three-dimensional shape of the target object at the first timing based on a difference between the first timing and the second timing; and generating three-dimensional data obtained by transforming the reference model using the transformation parameter after the correction.

A program according to a third aspect of the present disclosure causes a computer to execute the following processing of: receiving first three-dimensional sensing data indicating a result of sensing a target object from a first sensor at a first timing and receiving second three-dimensional sensing data indicating a result of sensing the target object from a second sensor provided in a position different from a position where the first sensor is provided at a second timing; calculating a transformation parameter of a representative point of a reference model used to transform a reference model indicating a three-dimensional shape of the target object into a three-dimensional shape of the target object indicated by the first three-dimensional sensing data and the second three-dimensional sensing data; correcting the transformation parameter in such a way that the reference model is transformed into a three-dimensional shape of the target object at the first timing based on a difference between the first timing and the second timing; and generating three-dimensional data obtained by transforming the reference model using the transformation parameter after the correction.

According to the present disclosure, it is possible to provide an analysis apparatus, a data generation method, and a program capable of generating high-quality three-dimensional data using data output from a plurality of sensors even when the plurality of sensors are unsynchronized with each other.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a configuration diagram of an analysis apparatus according to a first example embodiment;

FIG. 2 is a configuration example of an AR communication system according to a second example embodiment;

FIG. 3 is a configuration example of an analysis apparatus according to the second example embodiment;

FIG. 4 is a diagram for describing an example of calculating a transformation parameter according to the second example embodiment;

FIG. 5 is a diagram for describing non-rigid transformation according to the second example embodiment;

FIG. 6 is a diagram for describing update of a reference model according to the second example embodiment;

FIG. 7 is a diagram for describing processing of correcting transformation parameters according to the second example embodiment;

FIG. 8 is a diagram for describing processing of correcting the transformation parameters according to the second example embodiment;

FIG. 9 is diagram for describing processing of generating an integrated reference model according to the second example embodiment;

FIG. 10 is a diagram for describing processing of calculating a transformation parameter according to the second example embodiment;

FIG. 11 is a diagram showing a flow of processing regarding generation of mesh data and update of the reference model according to the second example embodiment;

FIG. 12 is a diagram showing a flow of processing regarding generation of the mesh data and update of the reference model according to the second example embodiment; and

FIG. 13 is a configuration example of an analysis apparatus and a user terminal according to each of the example embodiments.

### EXAMPLE EMBODIMENT

### First Example Embodiment

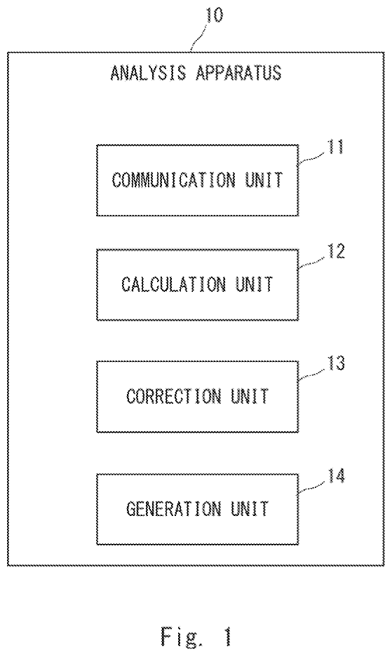

Hereinafter, with reference to the drawings, example embodiments of the present disclosure will be described. With reference to FIG. 1, a configuration example of an analysis apparatus 10 according to a first example embodiment will be described. The analysis apparatus 10 may be a computer apparatus that is operated by a processor executing a program stored in a memory. For example, the analysis apparatus 10 may be a server device.

The analysis apparatus 10 includes a communication unit 11, a calculation unit 12, a correction unit 13, and a generation unit 14. Each of the communication unit 11, the calculation unit 12, the correction unit 13, and the generation unit 14 may be software or a module whose processing is executed by a processor executing the program stored in the memory. Alternatively, each of the communication unit 11, the calculation unit 12, the correction unit 13, and the generation unit 14 may be hardware such as a circuit or a chip.

The communication unit 11 receives first three-dimensional sensing data that indicates results of sensing a target object at a first timing from a first sensor. The communication unit 11 further receives second three-dimensional sensing data that indicates results of sensing the target object at a second timing from a second sensor provided in a position different from a position where the first sensor is provided.

The first sensor and the second sensor may be, for example, 3D sensors. The first sensor is provided in a position that is different from a position where the second sensor is provided, and these sensors sense the target object from respective different angles. Sensing of the target object may indicate, for example, that images of the target object are captured using a camera. Therefore, sensing of a target object may instead be referred to as capturing of the target object. The timing when the first sensor senses the target object is not synchronized with the timing when the second sensor senses the target object. Instead of the term “timing”, the term “time” may sometimes be used.

The first sensor and the second sensor each generate three-dimensional sensing data by sensing the target object. The three-dimensional sensing data is data including, besides two-dimensional image data, depth data. The depth data is data indicating the distance from a sensor to the target object. The two-dimensional image data may be, for example, Red Green Blue (RGB) image data.

The calculation unit 12 calculates transformation parameters of representative points of a reference model used to transform the reference model indicating a three-dimensional shape of the target object into three-dimensional shapes of the target object indicated by the first three-dimensional sensing data and the second three-dimensional sensing data. The reference model indicating the three-dimensional shape may be, for example, mesh data, a mesh model, or polygon data, and may also be referred to as three-dimensional data. The reference model may be generated using, for example, three-dimensional sensing data generated by the first sensor and the second sensor sensing the target object. The reference model may be generated for each of the pieces of three-dimensional sensing data generated by the first sensor and the second sensor. Alternatively, the reference model may be generated using data obtained by integrating or synthesizing the three-dimensional sensing data generated by the first sensor and the second sensor.

The transformation parameters may be, for example, parameters for transforming a point cloud of the reference model into a point cloud of three-dimensional shapes of the target object indicated by the first three-dimensional sensing data and the second three-dimensional sensing data.

The correction unit 13 corrects a transformation parameter so as to transform the reference model into a three-dimensional shape of the target object at the first timing based on a difference between the first timing and the second timing. The difference between the first timing and the second timing may also be referred to as a time difference.

Assume, for example, that the time indicated by the second timing is later than the time indicated by the first timing. In this case, the amount of change when the reference model is transformed into a three-dimensional shape of the target object at the second timing is larger than the amount of change when the reference model is transformed into the three-dimensional shape of the target object at the first timing. Therefore, the transformation parameter may be corrected in such a way that it corresponds to the amount of change when the reference model is transformed into the three-dimensional shape of the target object at the first timing using the difference between the first timing and the second timing.

The generation unit 14 generates three-dimensional data obtained by transforming the reference model using the transformation parameter after the correction. The reference model transformed using the transformation parameter after the correction indicates the three-dimensional shape of the target object at the first timing.

As described above, the analysis apparatus 10 according to the first example embodiment generates three-dimensional data indicating the three-dimensional shape of the target object by applying the transformation parameter to the reference model. The analysis apparatus 10 then transforms the transformation parameter based on the difference between the timing when the first sensor performs sensing and the timing when the second sensor performs sensing. That is, the transformation parameter is corrected in such a way that the amount of change when the transformation parameter is applied to the reference model indicates the amount of change at the first timing. Accordingly, the analysis apparatus 10 is able to transform the reference model into the three-dimensional data indicating the three-dimensional shapes indicated by the three-dimensional sensing data sensed at timings different from each other.

### Second Example Embodiment

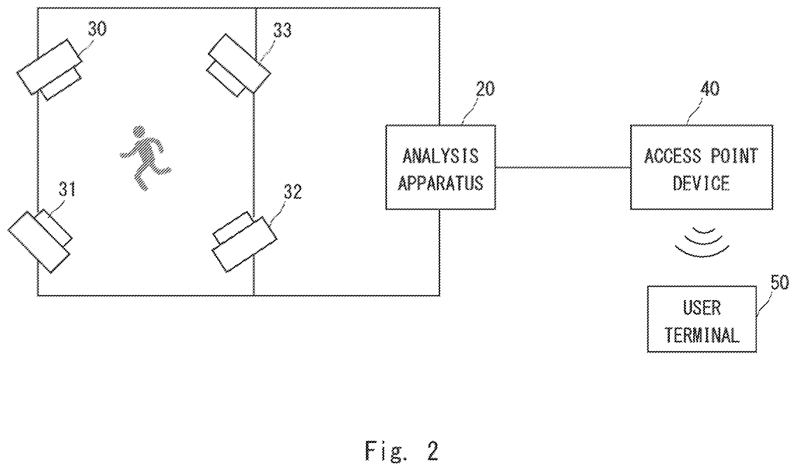

Referring next to FIG. 2, a configuration example of an AR communication system according to a second example embodiment will be described. The AR communication system shown in FIG. 2 includes an analysis apparatus 20, cameras 30-33, an access point device 40, and a user terminal 50. The analysis apparatus 20 corresponds to the analysis apparatus 10 shown in FIG. 1. While FIG. 2 shows a configuration example of the AR communication system including four cameras, the number of cameras is not limited to four.

The cameras 30-33 are specific examples of the 3D sensors and may be devices other than the cameras that acquire three-dimensional data of the target object. The cameras 30-33, which are, for example, 3D cameras, each generate point cloud data of the target object. The point cloud data includes values regarding the positions of the target object on the two-dimensional plane in the images generated by the respective cameras and the distance from each camera to the target object. The image indicated by the point cloud data, which is an image indicating the distance from the camera to the target object, may be referred to as, for example, a depth image or a depth map. The cameras 30-33 each capture images of the target object and transmit the point cloud data, which is captured data, to the analysis apparatus 20 via a network.

The analysis apparatus 20 receives the point cloud data from the cameras 30-33 and generates analysis data that is necessary to cause the user terminal 50 to display the target object. The analysis data may be, for example, three-dimensional data indicating the target object.

The access point device 40, which is, for example, a communication device that supports wireless Local Area Network (LAN) communication, may be referred to as a wireless LAN master unit. On the other hand, the user terminal 50 that performs wireless LAN communication with the access point device 40 may be referred to as a wireless LAN slave unit.

The user terminal 50 may be, for example, an xR device, and specifically, an AR device. The user terminal 50 performs wireless LAN communication with the access point device 40 and receives analysis data generated in the analysis apparatus 20 via the access point device 40. Note that the user terminal 50 may receive analysis data from the analysis apparatus 20 via a mobile network, without performing wireless LAN communication. The user terminal 50 may receive analysis data from the analysis apparatus 20 via a fixed communication network such as an optical network.

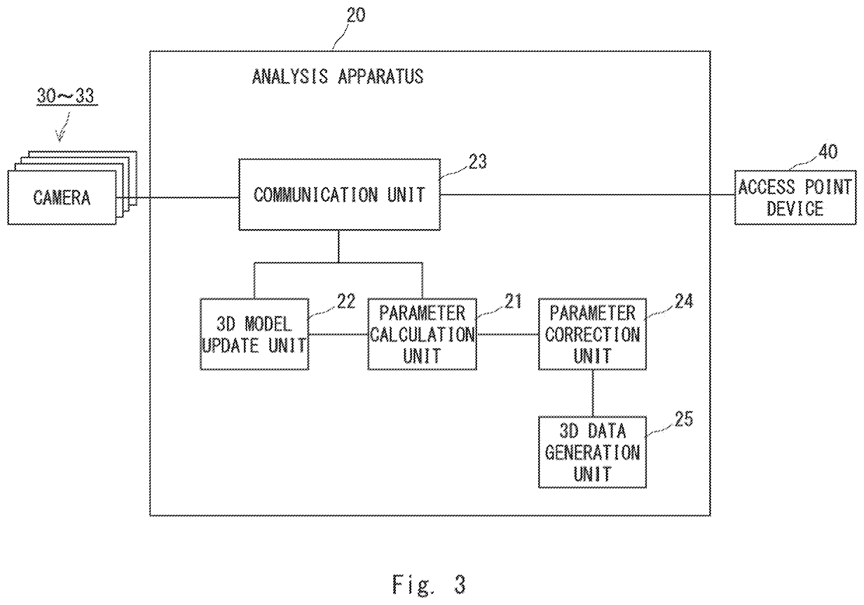

Referring next to FIG. 3, a configuration example of the analysis apparatus 20 will be described. The analysis apparatus 20 includes a parameter calculation unit 21, a 3D model update unit 22, a communication unit 23, a parameter correction unit 24, and a 3D data generation unit 25. The parameter calculation unit 21, the 3D model update unit 22, the communication unit 23, the parameter correction unit 24, and the 3D data generation unit 25 may each be software or a module whose processing is executed by executing a program. Further, each of the parameter calculation unit 21, the 3D model update unit 22, the communication unit 23, the parameter correction unit 24, and the 3D data generation unit 25 may be hardware such as a circuit or a chip. The parameter calculation unit 21 corresponds to the calculation unit 12 shown in FIG. 1. The communication unit 23 corresponds to the communication unit 11 shown in FIG. 1. The parameter correction unit 24 corresponds to the correction unit 13 shown in FIG. 1. The 3D data generation unit 25 corresponds to the generation unit 14 shown in FIG. 1.

The communication unit 23 receives point cloud data including the target object from the cameras 30-33. The communication unit 23 outputs the received point cloud data to the 3D model update unit 22. The 3D model update unit 22 creates a reference model if it has not yet created one regarding the target object. For example, the 3D model update unit 22 may synthesize the respective pieces of point cloud data received from the respective cameras and generate point cloud data including the target object. Synthesizing the point cloud data may instead be referred to as integrating the point cloud data. For example, Iterative Closest Point (ICP), posture estimation processing or the like may be used to integrate the point cloud data. For example, Perspective-n-Point (PnP) solver may be used for posture estimation processing. Further, the 3D model update unit 22 generates the reference model of the target object from the point cloud data. The reference model is composed of a point cloud and representative points having transformation parameters, the representative points being included in the point cloud. By transforming the reference model, it becomes possible to obtain a new point cloud and generate mesh data from the obtained point cloud. Generating mesh data may instead be referred to as constructing a mesh. The mesh data is data that shows a stereoscopic shape of the surface of the target object by a triangular surface or a quadrilateral surface obtained by combining the respective vertices with one another, the vertices being points included in the point cloud data. Alternatively, the 3D model update unit 22 may generate the reference model of the target object for each of the respective pieces of point cloud data without integrating the pieces of point cloud data received from the respective cameras.

The 3D model update unit 22 stores the reference model in a memory or the like in the analysis apparatus 20. Further, the 3D model update unit 22 transmits data regarding the reference model to the user terminal 50 via the communication unit 23 and the access point device 40. The data regarding the reference model may include data indicating the positions of the vertices and vertices including transformation parameters. Alternatively, if the user terminal 50 is able to generate mesh data from the point cloud data, like in the 3D model update unit 22, the 3D model update unit 22 may transmit point cloud data obtained by synthesizing the pieces of point cloud data generated in the respective cameras to the user terminal 50. The user terminal 50 receives the reference model or the user terminal 50 generates the reference model from the point cloud data, like in the 3D model update unit 22, whereby the analysis apparatus 20 and the user terminal 50 share one reference model.

If the communication unit 23 has received the point cloud data from the cameras 30-33 after the reference model is generated in the 3D model update unit 22, the parameter calculation unit 21 calculates the transformation parameter using the reference model and the point cloud data. Here, the parameter calculation unit 21 may generate the point cloud data obtained by synthesizing the pieces of point cloud data generated in the respective cameras, like in the 3D model update unit 22. Alternatively, the parameter calculation unit 21 may receive point cloud data after the synthesis from the 3D model update unit 22 when the respective pieces of point cloud data have been synthesized in the 3D model update unit 22.

Further, the parameter calculation unit 21 may calculate the transformation parameter using the respective pieces of point cloud data without synthesizing the pieces of point cloud data generated in the respective cameras.

The parameter calculation unit 21 extracts representative points from the vertices of the reference model and generates representative point data indicating the representative points. The parameter calculation unit 21 may randomly extract the representative points from all the vertices included in the reference model or may extract the respective points by executing the k-means method in such a way that the representative points are equally arranged in the target object. The parameter calculation unit 21 calculates the transformation parameters in such a way that the vertices of the reference model indicate the three-dimensional shape of the target object indicated by the point cloud data received from the cameras 30-33 after the reference model is generated. The three-dimensional shape of the target object indicated by the point cloud data received from the cameras 30-33 may be a three-dimensional shape of the target object indicated by the point cloud data after the respective pieces of point cloud data of the respective cameras are synthesized. Alternatively, the three-dimensional shape of the target object indicated by the point cloud data received from the cameras 30-33 may be a three-dimensional shape of the target object indicated by the respective pieces of point cloud data without synthesizing the respective pieces of point cloud data of the respective cameras.

The transformation parameter is calculated for each representative point. When there are n (n is an integer equal to or larger than 1) representative points, the transformation parameter is represented by a transformation parameter Wₖ. The symbol k, which is a value for identifying the representative point, may be a value from 1 to n. All the transformation parameters may be indicated as the transformation parameter W=[W₁, W₂, W₃, . . . Wₙ]. The transformation parameter Wₖ may include a rotation matrix Rₖ and a translation matrix Tₖ and may be represented by Wₖ=[Rₖ|Tₖ]. If a vertex of the reference model is denoted by a vertex vᵢ, a vertex v′ᵢ after the transformation may be represented by v′ᵢ=Σαₖ(vᵢ)·Qₖ(vᵢ), Qₖ(vᵢ)=Rₖ·(vᵢ−vₖ)+vₖ+Tₖ. The symbol “·” indicates multiplication. The symbol vₖ denotes the representative point of the reference model, αₖ is a function for calculating the closeness between the representative point vₖ and the vertex vᵢ, and the total sum becomes 1, that is, Σαₖ(vᵢ)=1. The value αₖ(vᵢ) becomes larger as vᵢ becomes closer to the representative point, that is, the vertex after the transformation becomes close to the representative point. This Qₖ(vᵢ) is one example of causing rotation and translation to act on a point, and another expression for causing rotation and translation to act on a point may instead be used.

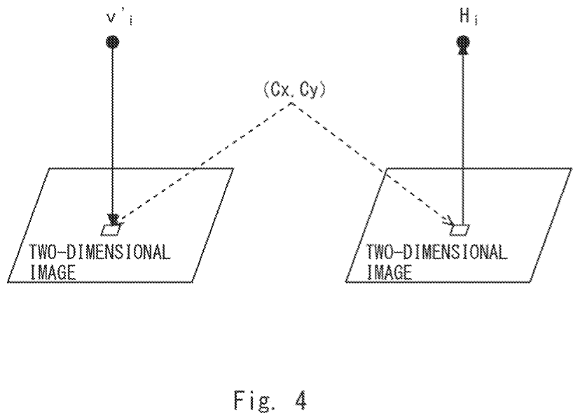

Now, an example of calculating the transformation parameter W=[W₁, W₂, W₃, . . . Wₙ] in the parameter calculation unit 21 will be described. The left view of FIG. 4 shows that the vertex v′ᵢ after the transformation has been projected onto coordinates (Cx, Cy) on a two-dimensional image. The two-dimensional image may be an image on the X-Y plane of the image shown using the point cloud data. Further, the right view of FIG. 4 shows a point Hᵢ on a three-dimensional space that corresponds to the coordinates (Cx, Cy) on the two-dimensional image of the point cloud data received after the generation of the reference model. Internal parameters of the camera are used for projection of the vertex v′ᵢ after the transformation onto the coordinates (Cx, Cy) on the two-dimensional image, and this projection is performed in such a way that its coordinate system becomes the same as the coordinate system on the two-dimensional image of the camera. The distance data of the vertex v′ᵢ after the transformation is denoted by v′ᵢ(D) and the distance data of the point Hₖ is denoted by Hₖ(D). The parameter calculation unit 21 calculates the transformation parameter W=[W₁, W₂, W₃, . . . Wₙ] that makes Σ|v′ᵢ(D)−Hᵢ(D)|² be a minimum. The part |v′ᵢ(D)−Hᵢ(D)| indicates an absolute value of v′ᵢ(D)−Hᵢ(D). Here, i in Σ|v′ᵢ(D)−Hᵢ(D)|² may have a value from 1 to m. The symbol m indicates the number of vertices of the reference model.

The parameter calculation unit 21 outputs the transformation parameter W and the point cloud data that have been generated in the respective cameras and have been received from the communication unit 23 to the parameter correction unit 24. The parameter correction unit 24 corrects the transformation parameter W and the 3D data generation unit 25 transforms the reference model using the transformation parameter after the correction. The 3D data generation unit 25 generates mesh data of the target object using the point cloud data after the reference model is transformed.

The 3D data generation unit 25 applies the transformation parameters W to the respective representative points included in the reference model and calculates representative points after the transformation. The 3D data generation unit 25 transforms the representative points using the transformation parameters W and the vertices other than the representative points are transformed using the transformation parameter W used for a nearby representative point. In this manner, transforming the positions of the representative points using the transformation parameters and transforming the positions of the vertices other than the representative points using the transformation parameter used in the nearby representative point may be referred to as non-rigid transformation.

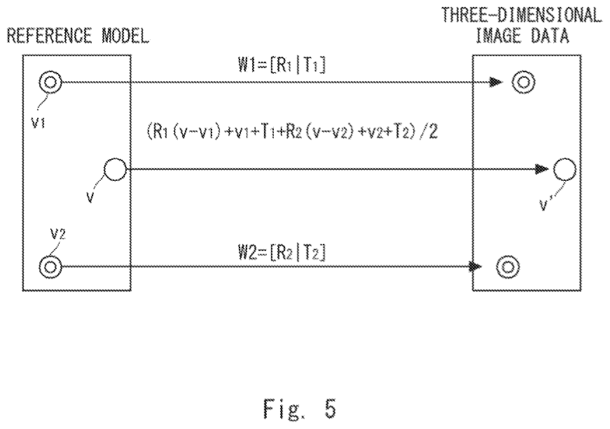

Next, with reference to FIG. 5, the non-rigid transformation will be described. FIG. 5 shows the positions of the vertices in the three-dimensional data regarding the three-dimensional shape indicated by the point cloud data received after the reference model is generated, after the vertices included in the reference model are transformed. In FIG. 5, double circles indicate the representative points and single circles indicate the vertices other than the representative points. For the sake of simplification of the description, a case in which only these three points are present in the reference model will be described. It is assumed here that the distances between the vertex v other than the representative points and each of two representative points are the same. At this time, αₖ(v)=0.5 (k=1, 2) is established and v′ after the transformation can be expressed by v′=(R₁·(v−v₁)+v₁+T₁+R₂·(v−v₂)+v₂+T₂)/2. The symbol “/” indicates division. The representative point vₖ may be set as α_{k′}(vₖ)=0.0 (k≠k′), α_{k′}(vₖ)=1.0 (k==k′) in such a way that it is not affected by the nearby representative point, or a transformation expression may be used like other vertices.

Referring once again to FIG. 3, the 3D data generation unit 25 transforms the point cloud of the reference model by performing non-rigid transformation, and generates mesh data using the point cloud after the transformation.

Next, processing of updating the reference model executed in the 3D model update unit 22 will be described. The 3D model update unit 22 applies an inverse transformation parameter W⁻¹ of the transformation parameter W calculated in the parameter calculation unit 21 to the point cloud data received after the reference model is generated. The point cloud data to which the inverse transformation parameter W⁻¹ is applied is transformed into point cloud data indicating a three-dimensional shape that is substantially the same as that of the reference model. A point cloud generated by performing, for example, processing of averaging on the reference model and the inversely-transformed point cloud is updated as a new reference model. Averaging may be performed by a weighted average or the like in which time is taken into account after, for example, the point cloud is expressed by a data structure by a Truncated Signed Distance Function (TSDF). The representative points may be newly generated based on the updated reference model or only representative points that have been greatly changed may be updated.

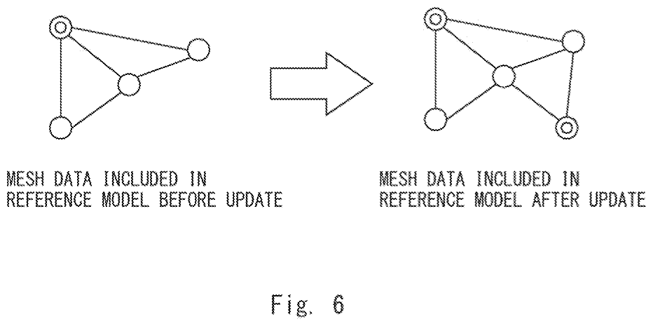

With reference to FIG. 6, the difference between the point cloud data after the inverse transformation parameter W⁻¹ is applied and the vertices of the reference model will be described. The left view in FIG. 6 shows mesh data included in the reference model before the update. Double circles indicate the representative points. Mesh data is shown by a triangular surface that uses three vertices. The right view shows mesh data in which the vertices after the inverse transformation parameter W⁻¹ has been applied is used. The mesh data in the right view is different from the mesh data in the left view in that the number of vertices in the mesh data in the right view is larger by one than that in the mesh data in the left view. While the added vertex is indicated as a representative point in FIG. 6, it may not be a representative point. Accordingly, by updating the reference model using the newly added vertex, the accuracy of the reference model can be improved. Each time the reference model is updated, the amount of information indicating the shape of the reference model is increased and the accuracy of indicating the target object is improved.

The 3D model update unit 22 transmits the difference data between the reference model before the update and the reference model after the update to the user terminal 50 via the communication unit 23. The difference data may include data regarding a vertex or a representative point that has been newly added to the reference model after the update or has been deleted from the reference model, and data regarding a vertex of a triangular surface or a quadrilateral surface that has been newly added.

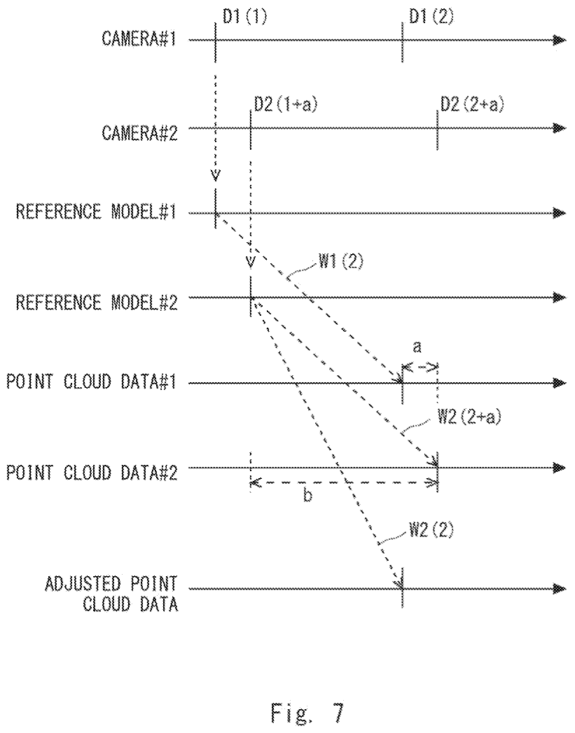

Next, with reference to FIG. 7, processing of correcting the transformation parameters in the parameter correction unit 24 will be described. The arrows in the horizontal direction in FIG. 7 indicate the time course. The direction of the arrows, i.e., rightwards arrows, indicates that time passes in this direction. The cameras #1 and #2 indicate, for example, two of the cameras 30-33. For the sake of simplification of the explanation, FIG. 7 shows processing of correcting transformation parameters when two cameras are used.

D1(1) indicated in the time series of the camera #1 indicates three-dimensional sensing data generated in the camera #1 at a timing 1. The number “1” as in the timing 1 is an identifier of a timing, not a time such as one second. The same is applied to the explanation regarding the timings described below. The three-dimensional sensing data may be, for example, point cloud data. D1(2) indicates three-dimensional sensing data generated in the camera #1 at a timing 2.

D2(1+a) indicated in the time series of the camera #2 indicates three-dimensional sensing data generated in the camera #2 at a timing 1+a. D2(2+a) indicates three-dimensional sensing data generated in the camera #2 at a timing 2+a. The symbol a may be, for example, a value larger than 0 and 1+a may indicate “a” seconds after the timing 1.

The reference model #1 is generated based on the three-dimensional sensing data generated in the camera #1. Specifically, the reference model #1 may be mesh data in a three-dimensional shape in which the respective points of the three-dimensional sensing data, which is the point cloud data, are combined with each other. For example, the reference model #1 is generated using D1(1).

The reference model #2 is generated based on the three-dimensional sensing data generated in the camera #2. For example, the reference model #2 is generated using D2(1+a). Since the camera #1 and the camera #2 are installed in positions different from each other, the displayed content of the target object captured by each camera differs from each other. For example, D1(1) may indicate a frontal image of the target object and D2(1+a) may indicate a back image of the target object. In this case, the reference model #1 may be a model showing the front of the target object and the reference model #2 may be a model showing the back of the target object.

The point cloud data #1 is D1(2) generated in the camera #1 and W1(2) indicates a transformation parameter applied to the reference model #1. Specifically, W1(2) is a transformation parameter for transforming the reference model #1 into a three-dimensional shape of the target object indicated by D1(2). In other words, W1(2) transits (transforms) the reference model #1 into a three-dimensional shape of the target object indicated by D1(2). The reference model #1 transformed using W1(2) may be indicated, for example, as point cloud data or may be indicated as three-dimensional data, which is mesh data.

The point cloud data #2 is D2(2+a) generated in the camera #2 and W2(2+a) indicates the transformation parameter applied to the reference model #2. Specifically, W2(2+a) is a transformation parameter for transforming the reference model #2 into a three-dimensional shape of the target object indicated by D2(2+a).

Incidentally, the time difference between the timing when D1(2) has been created and the timing when D2(2+a) has been created is denoted by “a” seconds. That is, the three-dimensional shape indicated by the three-dimensional data transformed from the reference model #2 using W2(2+a) indicates the shape after “a” seconds have passed since the three-dimensional shape indicated by the three-dimensional data transformed from the reference model #1 using W1(2).

The parameter correction unit 24 corrects the transformation parameter W2(2+a) to W2(2) in such a way that the three-dimensional data transformed from the reference model #2 using W2(2+a) indicates the three-dimensional shape at a timing that is substantially the same as the timing when D1(2) has been generated. Specifically, the parameter correction unit 24 calculates the transformation parameter W2(2) at the timing 2 using b, which is the time difference between D2(1+a) and D2(2+a), and a. Specifically, the rotation matrix and the translation matrix of the representative point of the transformation parameter W2(2+a) are denoted by Rₖ and Tₖ. If it is assumed that Rₖ satisfies Rₖ=f((φₖ, θₖ, ψₖ), where the roll φₖ, the pitch θₖ, and the yaw ψₖ are parameters, the rotation matrix of W2(2) becomes f(φₖ·(b−a)/b, θₖ·(b−a)/b, ψₖ·(b−a)/b). Further, the translation matrix becomes Tₖ·(b−a)/b. The reference model after the transformation indicate the three-dimensional shape of the target object indicated by the point cloud data sensed in the camera #2 at a timing that is substantially the same as the timing when D1(2) has been generated. In other words, it can be said that W2(2) is a transformation parameter for bringing the point cloud data after the transformation obtained using W2(2+a) back to “a” seconds ago. In FIG. 7, the reference model #2 after being transformed using W2(2) is indicated as adjusted point cloud data.

The 3D data generation unit 25 integrates the point cloud data #1 transformed from the reference model #1 using the transformation parameter W1(2) with the adjusted point cloud data transformed from the reference model #2 using the transformation parameter W2(2). For example, the 3D data generation unit 25 integrates the point cloud data #1 with the adjusted point cloud data using ICP or posture information on each camera. Further, the 3D data generation unit 25 generates mesh data using the integrated point cloud data. The mesh data thus generated indicates the three-dimensional shape of the target object at the timing when D1(2) has been generated.

The reference model #1 is updated using the point cloud data obtained by applying the inverse transformation parameter W⁻¹1(2) to the point cloud data #1. Further, the reference model #2 is updated using the point cloud data obtained by applying the inverse transformation parameter W⁻¹2(2+a) to the point cloud data #2.

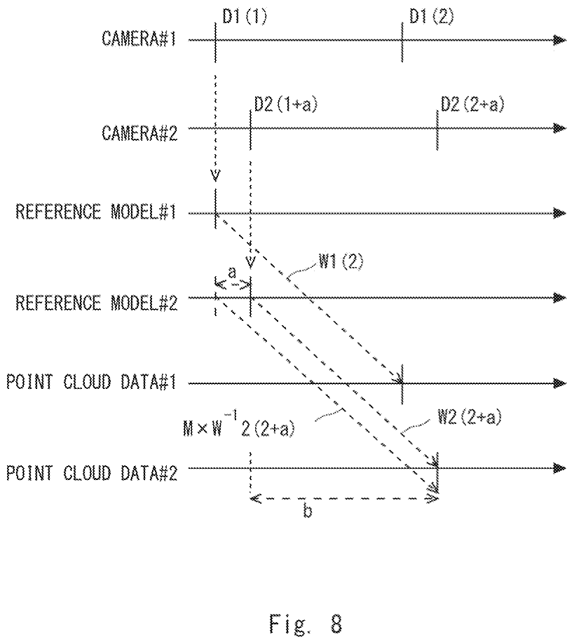

Referring next to FIG. 8, processing of correcting the transformation parameters in the parameter correction unit 24, the processing being different from that shown in FIG. 7, will be described. The reference model #1 is generated using the three-dimensional sensing data D1(1) generated in the camera #1, like in FIG. 7. The three-dimensional sensing data may be, for example, point cloud data. The reference model #2 is also generated using the three-dimensional sensing data D2(1+a) generated in the camera #2, like in FIG. 7.

The transformation parameters W1(2) and W2(2+a), which are similar to those shown in FIG. 7, respectively transform the reference model #1 and the reference model #2 into three-dimensional shapes indicated by D1(2) or D2(2+a).

The parameter correction unit 24 corrects the transformation parameter W2(2+a) so as to indicate the three-dimensional shape indicated by the three-dimensional sensing data captured by the camera #2 at a timing that is substantially the same as the timing when D1(1) has been generated using W2(2+a). The transformation parameter after the correction is calculated by multiplying the inverse transformation parameter W⁻¹2(2+a) by a coefficient M.

The time difference between D1(1) and D2(1+a) is a. Further, the time difference between D2(1+a) and D2(2+a) is denoted by b. The rotation matrix and the translation matrix of the representative point k in W⁻¹2(2+a) are respectively denoted by Rₖ and Tₖ. If Rₖ satisfies Rₖ=f(φₖ, θₖ, ψₖ), where the roll φₖ, the pitch θₖ, and the yaw ψₖ are parameters, the rotation matrix and the translation matrix of W⁻¹2(2+a)′ for bringing back to a timing that is substantially the same as the timing when D1(1) has been generated are respectively referred to as Rₖ′ and Tₖ′. In this case, Rₖ′=f(φₖ·(b+a)/b, θₖ(b+a)/b, ψₖ·(b+a)/b) is established and the translation matrix becomes Tₖ·(b+a)/b. The 3D model update unit 22 generates the reference model #2 of the target object captured by the camera #2 at a timing that is substantially the same as the timing when D1(1) has been generated using the point cloud data after the transformation using W⁻¹2(2+a)′.

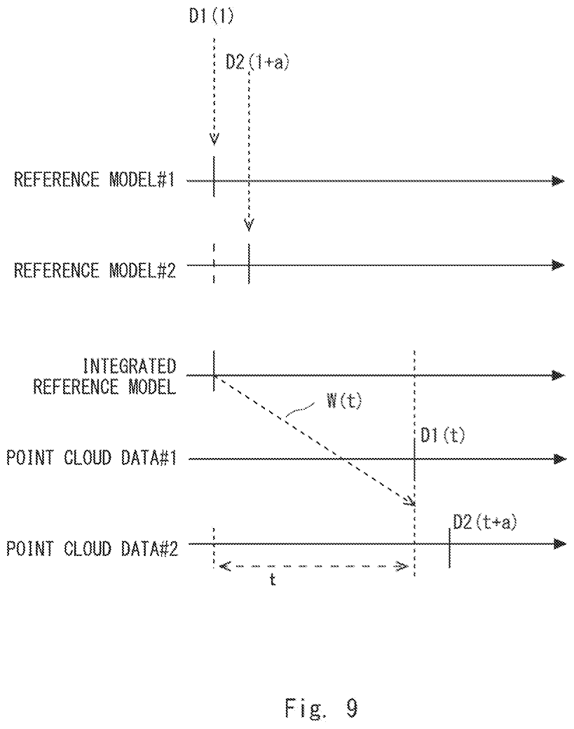

With reference now to FIG. 9, generation of the integrated reference model will be described. In FIG. 9 as well, like in FIGS. 7 and 8, the arrows in the horizontal direction indicate the time course. The direction of the arrows, i.e., rightwards arrows, indicates that time passes in this direction.

The solid line of the reference model #1 on the horizontal arrow in FIG. 9 indicates the reference model #1 of the target object at the timing when D1(1) has been generated in the camera #1. Further, the solid line of the reference model #2 on the horizontal arrow indicates the reference model #2 of the target object at the timing when D2(1+a) has been generated in the camera #2. The dotted line of the reference model #2 on the horizontal arrow indicates the reference model #2 of the target object indicated by the point cloud data generated in the camera #2 at a timing that is substantially the same as the timing when D1(1) has been generated in the camera #1.

The 3D model update unit 22 integrates the reference model #1 of the target object at the timing when D1(1) has been generated in the camera #1 with the reference model #2 of the target object regarding the camera #2 at the timing when D1(1) has been generated in the camera #1. The 3D model update unit 22 integrates the reference model #1 with the reference model #2, thereby generating the integrated reference model. The 3D model update unit 22 integrates two reference models using, for example, ICP or posture information on each camera, thereby generating the integrated reference model. Further, the reference models may be integrated on a data structure by a Truncated Signed Distance Function (TSDF). The integrated reference model is a reference model generated using the integrated point cloud data obtained by integrating point cloud data captured by the cameras #1 and #2 at the timing when D1(1) has been generated in the camera #1.

Next, with reference to FIG. 9, processing of calculating the transformation parameter W(t) based on the integrated reference model will be described. The symbol W(t) is a transformation parameter at the timing t, W(t)=[W₁, W₂, W₃, . . . Wₙ], and is a set of transformation parameters regarding the respective representative points. D1(t) is point cloud data generated in the camera #1 at the timing t and D2(t+a) is point cloud data generated in the camera #2 at the timing t+a. Further, the time difference between D1(1) and D1(t) is denoted by t.

The parameter correction unit 24 calculates, using v′ᵢ(t)=Σαₖ(vᵢ)·Qₖ(vᵢ), Qₖ(vᵢ)=Rₖ(t, g(t))·(vᵢ−vₖ)+vₖ+Tₖ(t, g(t)), Rₖ(t, g(t))−f(g(t)×φₖ(t), g(t)×θₖ(t), g(t)×ψₖ(t)), Tₖ(t, g(t))=g(t)×Tₖ, the vertex v′ᵢ(t) after the transformation of the reference model using the transformation parameter W(t). The part v′ᵢ(t) indicates the vertex after the transformation of the integrated reference model. Further, the parameter correction unit 24 projects the vertex v′ᵢ(t) after the transformation onto the coordinates (Cx, Cy) on the two-dimensional image using a method the same as the method of projecting D1(t) onto the two-dimensional space. When D1(t) is formed of a two-dimensional depth image, the vertex v′ᵢ(t) after the transformation is projected in such a way that its coordinate system becomes the same as that of the depth image. The point on the three-dimensional space that corresponds to (Cx, Cy) in D1(t) is denoted by Hₜ. The parameter correction unit 24 sets g(t)=1 when it projects the vertex v′ᵢ(t) after the transformation onto a two-dimensional image the same as the two-dimensional image that D1(t) has. The transformation parameter at this time is denoted by W(t). Further, the parameter correction unit 24 projects the representative point v′ᵢ(t+a) after the transformation onto the coordinates (Cx, Cy) on the two-dimensional image using a method the same as the method of projecting D2(t+a) onto a two-dimensional space. Here, the parameter correction unit 24 calculates v′ₖ(t+a) as g(t)=(t+a)/t when it projects the representative point v′ᵢ(t+a) after the transformation. The transformation parameter at this time is denoted by W(t+a).

When the integrated reference model is transformed using the transformation parameter W(t), it is transformed into a point indicating the three-dimensional shape of the target object at a timing substantially the same as the timing when D1(t) has been generated. However, the point cloud data #2 is D2(t+a) generated after, for example, “a” seconds since D1(t) has been generated. The parameter correction unit 24 is able to transform the reference model into the point indicating the three-dimensional shape of the target object at the timing when D2(t+a) has been generated by setting g2=(t+a)/t when it projects the representative point v′ᵢ(t+a) after the transformation onto a two-dimensional image that is the same as the two-dimensional image that D2(t+a) has.

The point on the three-dimensional space that corresponds to (Cx′, Cy′) in D2(t+a) is denoted by H′t. The parameter correction unit 24 calculates such a transformation parameter W(t)=[W₁, W₂, W₃, . . . Wₙ] that makes Σ{(v′ₖ(t,D)−Hₖ(t,D))²+(v′ₖ(t+a,D)−H′ₖ(t+a,D))²} be a minimum. The symbol k may be a value from 1 to n. The part (t,D) in v′ₖ(t,D) and Hₖ(t,D) indicates that it is distance data from the two-dimensional image plane at the timing t.

The 3D data generation unit 25 generates three-dimensional data of the target object at the timing t by transforming the integrated reference model using the transformation parameter W(t).

The integrated reference model is updated using the point cloud data obtained by applying the inverse transformation parameter W⁻¹(t) to the point cloud data #1 (D1(t)) and the point cloud data obtained by applying the inverse transformation parameter W⁻¹(t+a) to the point cloud data #2 (D2(t+a)).

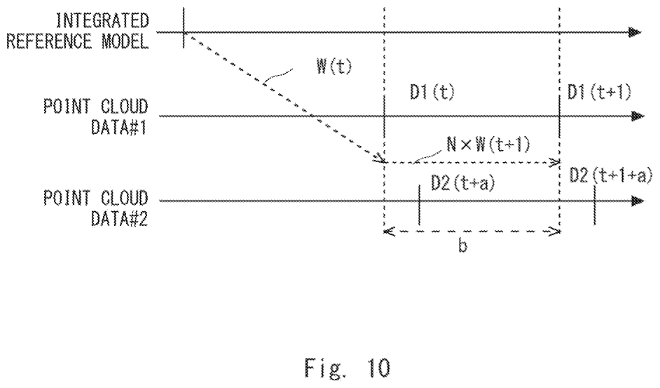

Referring next to FIG. 10, processing of calculating the transformation parameter W(t+1) based on the integrated reference model will be described. In FIG. 10, processing of calculating W(t+1) using W(t) calculated in FIG. 9 will be described. The transformation parameter W(t+1) for D1(t+1) is calculated, just like W(t) calculated in FIG. 9. Further, W(t+1+a) is calculated, assuming Rₖ(t+1+a, g(t+1+a)) and Tₖ(t+1+a, g(t+1+a)), using Rₖ(t+1+a, g(t+1+a))−f(g(t+1+a)×(φₖ(t+1)−φₖ(t))+φₖ(t), g(t+1+a)×(θₖ(t+1)−θₖ(t))+θₖ(t+1), g(t+1+a)×(ψₖ(t+1)−ψₖ(t))+ψₖ(t+1)), Tₖ(t+1+a, g(t+1+a))=g(t+1+a)×(Tₖ(t+1, g(t+1))−Tₖ(t, g(t)))+Tₖ(t, g(t)). Here, g(t+1+a)=a/b is established.

The parameter correction unit 24 calculates, using v′ᵢ(t+1)=Σαₖ(vᵢ)·Qₖ(vᵢ), Qₖ(vᵢ)=Rₖ·(vᵢ−vₖ)+vₖ+Tₖ, the vertex v′ᵢ(t+1) after the transformation using the transformation parameter W(t+1). The part vₖ(t) indicates the representative point included in the point cloud of the integrated reference model. Further, the parameter correction unit 24 projects the vertex v′ᵢ(t+1) after the transformation onto the coordinates (Cx, Cy) on a two-dimensional image that is the same as the two-dimensional image that D1(t+1) has. Further, the point on the three-dimensional space that corresponds to (Cx, Cy) in D1(t+1) is denoted by Hᵢ. Further, the parameter correction unit 24 projects the vertex v′ᵢ(t+1) after the transformation onto coordinates (Cx′, Cy′) on a two-dimensional image that is the same as the two-dimensional image that D2(t+1+a) has. Here, the parameter correction unit 24 calculates v′ᵢ(t+1+a) using W(t+1+a) when the vertex v′ᵢ(t+1) after the transformation is projected onto the two-dimensional image that is the same as the two-dimensional image that D2(t+1+a) has. On the other hand, the parameter correction unit 24 sets g=g1=1 when the vertex v′ᵢ(t+1) after the transformation is projected onto the two-dimensional image that is the same as the two-dimensional image that D1(b+1) has.

The point on the three-dimensional space that corresponds to (Cx′, Cy′) in D2(t+1+a) is denoted by H′ᵢ. The parameter correction unit 24 calculates such a transformation parameter W(t+1)=[W₁, W₂, W₃, . . . Wₙ] that makes Σ{(v′ᵢ(t+1,D)−Hᵢ(t+1,D))²+(v′ᵢ(t+1+a,D)−H′ᵢ(t+1+a,D))²} be a minimum.

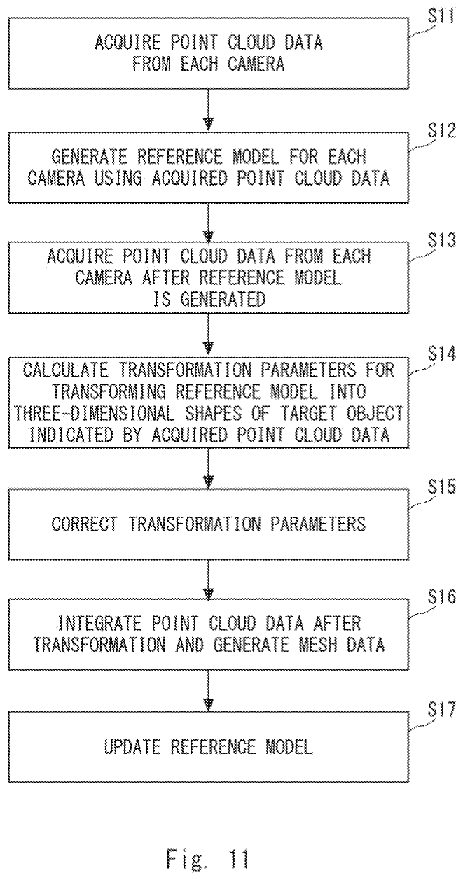

Referring next to FIG. 11, a flow of processing regarding generation of the mesh data and update of the reference model in the configuration described with reference to FIG. 7 will be described. First, the communication unit 23 receives point cloud data including the target object from each of the cameras 30-33 (S11). Next, the 3D model update unit 22 generates the reference model of the target object captured for each camera using the acquired point cloud data (S12). For example, the 3D model update unit 22 generates mesh data indicating the stereoscopic shape of the target object using a triangular surface or a quadrilateral surface in which the respective points included in the point cloud data are combined with each other.

Next, the communication unit 23 further acquires, after it has acquired point cloud data from each of the cameras in Step S11, the point cloud data from each of the cameras (S13). The newly received point cloud data, which is data indicating a substantially real-time three-dimensional shape of the target object, may be referred to as real-time data. Next, the parameter calculation unit 21 calculates transformation parameters for transforming the reference model generated in the 3D model update unit 22 into three-dimensional shapes of the target object indicated by the point cloud data acquired in Step S13 (S14). The transformation parameter is calculated for each representative point among the vertices that form the reference model.

Next, the parameter correction unit 24 corrects the transformation parameters calculated in Step S14 (S15). The parameter correction unit 24 corrects, for example, the transformation parameters regarding the camera #2 included in the cameras 30-33 in such a way that the transformation parameters are transformed into the three-dimensional shapes of the target object at a timing that is substantially the same as the timing when the point cloud data has been generated in the camera #1. Correcting the transformation parameters may be equal to decreasing or increasing the amount of change of the reference model regarding the respective cameras. There is a case, for example, in which the timing when the camera #2 generates point cloud data is later than the timing when the camera #1 generates point cloud data. In this case, the transformation parameters are corrected in such a way that the amount of change of the reference model regarding the camera #2 is reduced in accordance with the timing when the camera #1 generates point cloud data.

Next, the 3D data generation unit 25 integrates point cloud data after vertices that form the reference model regarding the respective cameras are transformed and generates mesh data (S16). The point cloud data after the transformation regarding the respective cameras indicates the three-dimensional shape of the target object at substantially the same timing.

Next, the 3D model update unit 22 updates the reference model using the calculated transformation parameters (S17). For example, the 3D model update unit 22 updates the reference model using the point cloud data obtained by applying the inverse transformation parameters to the point cloud data generated in the respective cameras.

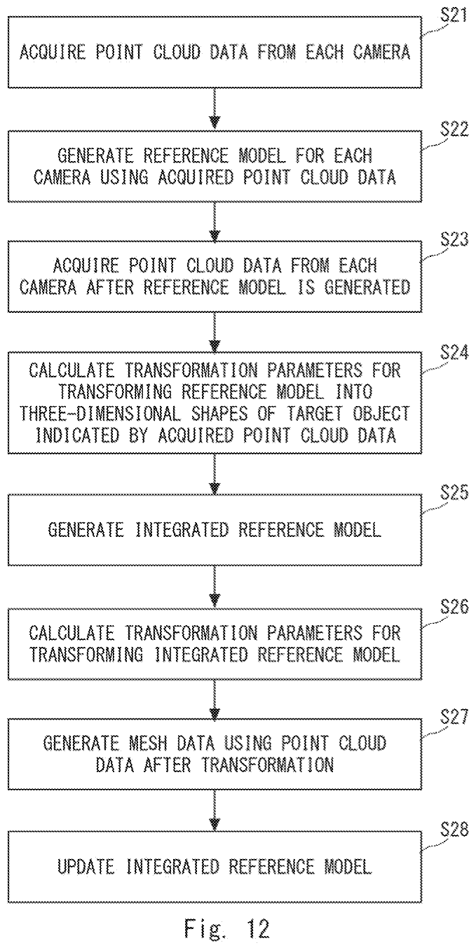

Referring next to FIG. 12, a flow of processing regarding generation of the mesh data and update of the reference model in the configurations described in FIGS. 8 and 9 will be described. Since Steps S21 to S24 are similar to Steps S11 to S14 in FIG. 11, the detailed descriptions will be omitted.

The 3D model update unit 22 generates, in Step S25, the integrated reference model (S25). Specifically, there is a difference between the timing when the camera #1 generates the point cloud data and the timing when the camera #2 generates the point cloud data. In this case, the 3D model update unit 22 specifies the point cloud data generated in the camera #2 at, for example, a timing that is substantially the same as the timing when the point cloud data has been generated in the camera #1. The 3D model update unit 22 integrates the pieces of point cloud data in the respective cameras generated at substantially the same timing, thereby generating the integrated reference model.

Next, the parameter correction unit 24 calculates the transformation parameters for transforming the integrated reference model (S26). The parameter correction unit 24 calculates, for example, the transformation parameter for transforming the integrated reference model so as to indicate the three-dimensional shape of the target object at the timing when the point cloud data is generated in the camera #1. At this time, the parameter correction unit 24 corrects the transformation parameter in such a way that the vertex after the transformation becomes consistent with the point cloud data generated in the camera #2.

Next, the 3D data generation unit 25 transforms the reference model using the calculated transformation parameter and generates the mesh data using the point cloud data after the transformation (S27).

Next, the 3D model update unit 22 updates the integrated reference model using the calculated transformation parameter (S27). The 3D model update unit 22 updates the integrated reference model using, for example, the point cloud obtained by applying the inverse transformation parameter to the point cloud data generated in the respective cameras.

As described above, the analysis apparatus 20 according to the second example embodiment corrects, when the reference model is transformed into a three-dimensional shape indicated by a plurality of pieces of point cloud data sensed at timings different from each other, the transformation parameter using the difference in the timings. In other words, the analysis apparatus 20 is able to make the point cloud data after the transformation be point cloud data sensed at substantially the same timing by adjusting the amount of change from the reference model transformed using the transformation parameter. Accordingly, the analysis apparatus 20 is able to prevent the quality of the three-dimensional data to be displayed on the user terminal 50 from being reduced even when the timings when a plurality of cameras perform sensing are not synchronized with one another.

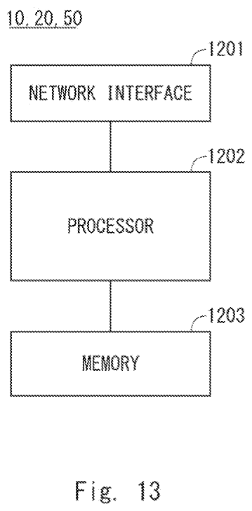

FIG. 13 is a block diagram showing a configuration example of the analysis apparatus 10, the analysis apparatus 20, and the user terminal 50 (hereinafter these components are denoted by “the analysis apparatus 10 and the like”). Referring to FIG. 13, the analysis apparatus 10 and the like include a network interface 1201, a processor 1202, and a memory 1203. The network interface 1201 may be used to communicate with another network node. The network interface 1201 may include, for example, a network interface card (NIC) that is in compliance with IEEE 802.3 series.

The processor 1202 loads software (computer program) from the memory 1203 and executes the loaded software (computer program), thereby performing processing of the analysis apparatus 10 and the like described with reference to the flowcharts in the above example embodiments. The processor 1202 may be, for example, a microprocessor, an MPU, or a CPU. The processor 1202 may include a plurality of processors.

The memory 1203 is composed of a combination of a volatile memory and a non-volatile memory. The memory 1203 may include a storage located away from the processor 1202. In this case, the processor 1202 may access the memory 1203 via an Input/Output (I/O) interface that is not shown.

In the example shown in FIG. 13, the memory 1203 is used to store software modules. The processor 1202 loads these software modules from the memory 1203 and executes the loaded software modules, thereby being able to perform processing of the analysis apparatus 10 and the like described in the above example embodiments.

As described with reference to FIG. 13, each of the processors included in the analysis apparatus 10 and the like in the above example embodiments executes one or more programs including instructions for causing a computer to execute the algorithm described with reference to the drawings.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the aforementioned example embodiments and may be changed as appropriate without departing from the spirit of the present disclosure.

### REFERENCE SIGNS LIST

10 Analysis Apparatus
11 Communication Unit
12 Calculation Unit
13 Correction Unit
14 Generation Unit
20 Analysis Apparatus
21 Parameter Calculation Unit
22 3D Model Update Unit
23 Communication Unit
24 Parameter Correction Unit
25 3D Data Generation Unit
30 Camera
31 Camera
32 Camera
33 Camera
40 Access Point Device
50 User Terminal

What is claimed is:

1. An analysis apparatus comprising:
at least one memory storing instructions, and
at least one processor configured to execute the instructions to;
receive first three-dimensional sensing data indicating a result of sensing a target object from a first sensor at a first timing and second three-dimensional sensing data indicating a result of sensing the target object from a second sensor provided in a position different from a position where the first sensor is provided at a second timing;
calculate a transformation parameter of a representative point of a reference model used to transform a reference model indicating a three-dimensional shape of the target object into a three-dimensional shape of the target object indicated by the first three-dimensional sensing data and the second three-dimensional sensing data;
correct the transformation parameter in such a way that the reference model is transformed into a three-dimensional shape of the target object at the first timing based on a difference between the first timing and the second timing; and
generate three-dimensional data obtained by transforming the reference model using the transformation parameter after the correction.

2. The analysis apparatus according to claim 1, wherein the at least one processor is further configured to execute the instructions to calculate a first transformation parameter used to transform a first reference model generated using three-dimensional sensing data indicating a result of the sensing in the first sensor into the three-dimensional shape of the target object indicated by the first three-dimensional sensing data and a second transformation parameter used to transform a second reference model generated using three-dimensional sensing data indicating a result of the sensing in the second sensor into the three-dimensional shape of the target object indicated by the second three-dimensional sensing data, and
correct the second transformation parameter in such a way that the reference model is transformed into the three-dimensional shape of the target object in a case in which the second sensor has sensed the target object at the first timing based on a difference between the first timing and the second timing.

3. The analysis apparatus according to claim 2, wherein the at least one processor is further configured to execute the instructions to generate integrated three-dimensional data in which first three-dimensional data obtained by transforming the first reference model using the first transformation parameter is integrated with second three-dimensional data obtained by transforming the second reference model using the second transformation parameter after the correction.

4. The analysis apparatus according to claim 2, wherein the at least one processor is further configured to execute the instructions to correct the second transformation parameter by multiplying, when an elapsed time from a time indicating the second timing to a time when the second sensor has sensed the target object in order to generate the second reference model is denoted by T and a time indicating the difference between the first timing and the second timing is denoted by t, a value obtained by dividing T+t by T by an amount of rotation and an amount of translation included in the second transformation parameter.

5. The analysis apparatus according to claim 1, wherein the at least one processor is further configured to execute the instructions to calculate the transformation parameter used to transform an integrated reference model generated by using three-dimensional sensing data sensed in the first sensor and three-dimensional sensing data sensed in the second sensor into the three-dimensional shape of the target object indicated by the first three-dimensional sensing data and the second three-dimensional sensing data.

6. The analysis apparatus according to claim 5, wherein the at least one processor is further configured to execute the instructions to calculate, if the position of a first vertex of a plurality of vertices of the integrated reference model has been transformed using the transformation parameter, the transformation parameter in such a way that the distance between a position of the first vertex after the transformation at a time of the three-dimensional sensing data sensed in the first sensor and a second vertex which is positioned at the same position in a two-dimensional space as the first vertex of a plurality of vertices included in the first three-dimensional sensing data and the distance between the position of the first vertex after the transformation at a time of the three-dimensional sensing data sensed in the second sensor and a third vertex which is positioned at the same position in a two-dimensional space as the first vertex of a plurality of vertices included in the second three-dimensional sensing data become a minimum.

7. The analysis apparatus according to claim 6, wherein the at least one processor is further configured to execute the instructions to correct the position of the first vertex after the transformation to the position of a fourth vertex based on a difference between the first timing and the second timing and calculate the transformation parameter in such a way that the distance between the position of the first vertex after the transformation and that of the second vertex and the distance between the position of the fourth vertex and that of a third vertex that corresponds to the first vertex of a plurality of vertices included in the second three-dimensional sensing data become a minimum.

8. A data generation method comprising:
receiving first three-dimensional sensing data indicating a result of sensing a target object from a first sensor at a first timing and receiving second three-dimensional sensing data indicating a result of sensing the target object from a second sensor provided in a position different from a position where the first sensor is provided at a second timing;
calculating a transformation parameter of a representative point of a reference model used to transform a reference model indicating a three-dimensional shape of the target object into a three-dimensional shape of the target object indicated by the first three-dimensional sensing data and the second three-dimensional sensing data;
correcting the transformation parameter in such a way that the reference model is transformed into a three-dimensional shape of the target object at the first timing based on a difference between the first timing and the second timing; and
generating three-dimensional data obtained by transforming the reference model using the transformation parameter after the correction.

9. A non-transitory computer readable medium storing a program for causing a computer to execute the following processing of:
receiving first three-dimensional sensing data indicating a result of sensing a target object from a first sensor at a first timing and receiving second three-dimensional sensing data indicating a result of sensing the target object from a second sensor provided in a position different from a position where the first sensor is provided at a second timing;
calculating a transformation parameter of a representative point of a reference model used to transform a reference model indicating a three-dimensional shape of the target object into a three-dimensional shape of the target object indicated by the first three-dimensional sensing data and the second three-dimensional sensing data;
correcting the transformation parameter in such a way that the reference model is transformed into a three-dimensional shape of the target object at the first timing based on a difference between the first timing and the second timing; and
generating three-dimensional data obtained by transforming the reference model using the transformation parameter after the correction.
